(19) United States
(12) Patent Application Publication
(10) Pub. No.: US 2011/0181459 A1
(43) Pub. Date: Jul. 28, 2011

(54) SYSTEMS AND METHODS FOR INCIDENT ANGLE MEASUREMENT OF WAVES IMPINGING ON A RECEIVER

(75) Inventor: Reinhard Feger, Scheffau (AT)

(73) Assignee: Infineon Technologies AG, Neubiberg (DE)

(21) Appl. No.: 12/695,546

(22) Filed: Jan. 28, 2010

(51) Int. Cl. G01S 13/42; G01S 13/08; G01S 13/00

(52) U.S. Cl. 342/146; 342/175; 342/147; 342/118

(57) ABSTRACT

Embodiments relate to radar systems and methods. In an embodiment, a system includes a radio frequency (RF) sensor array comprising a plurality of spaced apart sensors; and a reflector element positioned proximate the RF sensor array to reflect waves toward the RF sensor array. In an embodiment, a system includes an antenna array comprising a transceive antenna and a plurality of receive antennas; a mirror arranged proximate the antenna array; a voltage controlled oscillator (VCO) configured to generate a signal to be transmitted by the transceive antenna; and a controller configured to resolve signals received by the plurality of receive antennas to determine an angular position of a target, wherein the signals received include a first portion of the signal reflected by the target and a second portion of the signal reflected by the target and the mirror.

### TECHNICAL FIELD

The invention relates generally to radio frequency (RF) systems and more particularly to improving the accuracy of measurement of incident angles using a reflector.

### BACKGROUND

One of the challenges in radar array system design is the improvement of the accuracy of direction of arrival measurements. It is known that for classical arrays the estimation performance depends on the number of array elements, as well as on the size of the array's aperture. Often it is impossible to increase both of these parameters. On one hand, increasing the number of array elements is prohibitive due to the costs associated with the larger amount of radio frequency (RF) circuitry, while on the other hand, the space needed for larger apertures simply might not be available. The need for an increased number of RF channels can be circumvented by the use of switched array configurations, but this does not solve the problem of increased space demands, and introduces the drawback of an increased measurement time.

Conventionally, these challenges have been addressed via classical beamforming or advanced signal processing algorithms. In classical beamforming, the signals of each sensor are collected and delayed according to the sensor positions and a possible incident angle. For each possible angle, a weighted sum of the delayed signals is then calculated to estimate the angular power distribution. Peaks in this power distribution are used as estimates for the incident angle. A drawback of this approach is that different waves impinging from closely spaced angles cannot be distinguished unless many sensors are used that form a very large sensor array. Furthermore, as previously mentioned, the angular accuracy is also influenced by the size of the sensor array used. Therefore, a large sensor is needed for accurate angle measurements.

Advanced signal processing algorithms overcome this problem by making use of additional information possibly available about the measurement scenario. For example, it can be assumed that waves impinging from different directions are completely uncorrelated, or that the number of different impinging waves is exactly known. Other information that can be exploited is the assumption that waves have (almost) zero angular spread or that the characteristics of the noise disturbing the measurement are exactly known. A drawback of these methods is that they cannot cope very well with deviations from the made assumptions. Furthermore, they require higher computational power due to the increased algorithm complexity compared to other conventional methods. Last but not least, these algorithms do not improve the achievable angular measurement variance in the single signal case.

### SUMMARY OF THE INVENTION

In an embodiment, a system comprises a radio frequency (RF) sensor array comprising a plurality of spaced apart sensors; and a reflector element positioned proximate the RF sensor array to reflect waves toward the RF sensor array.

In an embodiment, a system comprises an antenna array comprising a transceive antenna and a plurality of receive antennas; a mirror arranged proximate the antenna array; a voltage controlled oscillator (VCO) configured to generate a signal to be transmitted by the transceive antenna; and a controller configured to resolve signals received by the plurality of receive antennas to determine an angular position of a target, wherein the signals received include a first portion of the signal reflected by the target and a second portion of the signal reflected by the target and the mirror.

In an embodiment, a method comprises transmitting a radio frequency (RF) signal; receiving a first portion of a reflected RF signal reflected by a target; receiving a second portion of a reflected RF signal reflected by a target and a reflector; and resolving the first and second portions to determine an angular position of a target.

In an embodiment, a method comprises increasing an effective array aperture of a radar sensor array by positioning a mirror proximate the radar sensor array, receiving target-reflected signals and target-and-mirror-reflected signals by the radar sensor array, and determining information about a target based on the target-reflected signals and target-and-mirror-reflected signals.

### BRIEF DESCRIPTION OF THE DRAWINGS

The invention may be more completely understood in consideration of the following detailed description of various embodiments of the invention in connection with the accompanying drawings, in which:

FIG. 1 is a diagram of an antenna array and reflector according to an embodiment.

FIG. 2 is an angular accuracy graph according to an embodiment.

FIG. 3 is a hardware block diagram of a radar system according to an embodiment.

FIG. 4 is a graph comparing least squares cost functions resulting from a conventional array and an array including a reflector element according to an embodiment.

FIG. 5 is a block diagram of a sensor plane and reflector element according to an embodiment.

FIG. 6 is a block diagram of a system according to an embodiment.

FIG. 7 is a graph comparing simulated and measured transmission beampatterns according to an embodiment.

FIG. 8 is a graph of measured variance improved compared to theoretical data according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Embodiments relate to hardware-based methods for improving the performance of radio frequency (RF) systems by using a reflector. While reflectors, such as metallic reflectors and the like, can be used in radar systems to create narrow beams and focus power, here the reflector acts as a mirror and reflects electromagnetic (EM) or acoustic waves impinging onto a conventional uniform receiver array. The function of the mirror can be interpreted as generating a second image of the observed scene or as producing a virtual copy of the antenna array. This makes it possible to increase the angular accuracy achievable with an array without the need for additional array elements. Further, multiple targets can be better resolved even if closely spaced. Because the signals coming from the real array and those coming from its virtual copy are not distinguishable, classical beamforming cannot be applied to the problem at hand. Therefore, embodiments also relate to methods for angle estimation based on a least-squares approach. Since the involved signals are a superposition of cisoids (complex exponentials), these methods deliver a result closely related to a discrete Fourier transform (DFT). Thus, the algorithm can be implemented very efficiently using fast Fourier transforms (FFTs), which again is very beneficial for the realization of low-cost and low power consuming systems.

Various embodiments have applicability to radar systems, such as high-frequency automotive radar systems operating at, e.g., 77 GHz. Other RF, acoustic and similar systems can also have applicability in embodiments. Therefore, examples and embodiments describing particular systems, such as automotive radar systems, are not limiting and merely exemplary of some embodiments.

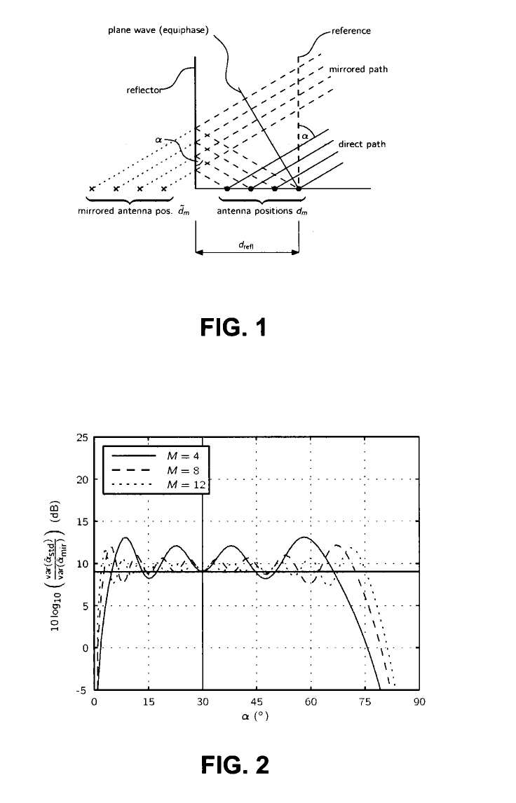

Referring to FIG. 1, a configuration of a reflector with exemplary paths of rays coming from a possible target is depicted. The antennas of a classical uniform linear array are situated at the positions dₘ (relative to an arbitrarily chosen array reference) marked with the dots, where m ε0 . . . M−1 denotes the antenna index and M the total number of antennas. In addition to the signals that impinge onto the array directly from a certain direction α, the reflector placed perpendicular to the antenna plane at a distance d_{refl} to the array's reference leads to secondary signal paths shown as dashed lines. Signals travelling along these paths impinge onto the array from the mirrored target position. As can be seen from FIG. 1, this can also be interpreted as a second array with the virtual positions

d̅ₘ=2d_{refl}−dₘ. (1)

In FIG. 1, these positions are each marked with an x. Thus, the number of sensors (antennas) is virtually doubled, which increases the overall virtual size of the array. The angle of the impinging wave is the same for the real and the mirrored array in this interpretation, whereas the virtual array is a flipped and shifted copy of the real array. From this result it can be deduced that the reflector can lead to a system with higher angular resolution as well as better angular accuracy. This assumption can be fulfilled if it is possible to find an adequate algorithm that is capable of making use of the additively overlayed information coming from the real and mirrored array.

The first step to design signal processing algorithms and to verify the achievable system accuracy is the development of the signal model. The usual assumptions of farfield operation and narrowband signals lead to the classical model that the time delays of the signals received at each array antenna can be approximated by linear phase shifts along the aperture of the array. The formulation without a mirror leads to the (noise free) array output vector at the time instance n:

s̅[n]=ā(α)sₐ[n]. (2)

Here sₐ[n] denotes an arbitrary signal impinging onto the array, and a(α) the steering vector which is defined as

ā(α)=[e^{jkd}^{₀} ^{sin(α)}e^{jkd}^{₁} ^{sin(α)} . . . e^{jkd}^{_{M-1}}^{sin(α)}]^{T}. (3)

The wavenumber k in (3) is defined as k=2π/λ, with λ being the wavelength of the narrowband electromagnetic wave received at the array. The snapshot from the mirrored antenna positions is defined as

\tilde{s}[n]=ã(α)sₐ[n], (4)

where according to (3) and (1) the steering vector of the mirrored elements is written as

ã(α)=[e^{jk\tilde{d}}^{₀} ^{sin(α)}e^{jk\tilde{d}}^{₁} ^{sin(α)} . . . e^{jk\tilde{d}}^{_{M-1}} ^{sin(α)}]^{T}. (5)

For the proposed system the received signals consist of a superposition of (2) and (4), which leads to the complete array snapshot vector

s[n]= s̅[n]+\tilde{s}[n]=(ā(α)+ã(α))sₐ[n]. (6)

According to (6) the complete array steering vector follows to

a(α)=ā(α)+ã(α)=ã(α)+e^{j2kd}^{_{refl}} ^{sin(α)}ā(α)*. (7)

Since there are N snapshots, (6) can be stacked to build a larger signal vector

sₘᵢᵣ=[s[0]^{T}s[1]^{T} . . . s[N−1]^{T}]^{T}, (8)

containing all snapshots. Thus, sε [symbol] . For comparison purposes we define the vector for a standard array in the same way to

s_{std}=[ s̅[0]^{T} s̅[1]^{T} . . . s̅[N−1]^{T}]^{T}, (9)

A method of comparing different systems with respect to the achievable performance is the Cramer-Rao lower-bound (CRLB). A calculation of this bound determines the minimal achievable measurement variance that can be attained with an unbiased estimator. Thus it is possible to compare system concepts with respect to their predicted achievable performance without the need to derive estimation algorithms and, e.g., run time-consuming Monte-Carlo simulations. In an embodiment, the radar system is a frequency-modulated continuous-wave (FMCW) radar system. Thus the signal travelling along the array aperture is known except for its complex amplitude, C̅=Ce^{jφ}, and the range-dependent frequency. The FMCW signal at the array reference due to a single target after the downconversion with the transmitted FMCW-signal can be written as

[symbol]

In (10), B denotes the sweep bandwidth, fₒ the sweep starting frequency, r the target range, and c the velocity of the EM wave. Applying the stacking scheme from (8) to the signal model, the elements of a Fisher information matrix can be calculated via

$${[ F ( θ ) ]}_{p , q} = \frac{2}{{σ}^{2}} Re \{ {\sum }_{k = 9}^{NM - 1} \frac{\partial {[ {s}_{arb} ]}_{k}^{*}}{\partial {[ θ ]}_{p}} \frac{\partial {[ {s}_{arb} ]}_{k}}{\partial {[ θ ]}_{q}} \} , \qquad ( 11 )$$

where s_{arb} is either the signal model (8) or (9). Equation (11) considers the case of complex-valued data and real-valued unknown parameters θ=[Crαφ]^{T}. For an arbitrarily spaced linear array, the CRLB gives a lower limit on the achievable angular variance resulting in

$$var ( {\hat{α}}_{std} ) \geq {[ {F ( θ )}^{- 1} ]}_{3 , 3} == \frac{{c}_{0}^{2}}{4 {π}^{2} {C}^{2} {f}_{0 }^{2} N ( {\sum }_{m = 0}^{M - 1} {d}_{m}^{2} - \frac{1}{M} {( {\sum }_{m = 0}^{M - 1} {d}_{m} )}^{2} )} \frac{{σ}^{2} / 2}{{cos}^{2} α} . \qquad ( 12 )$$

For a uniform array with dₘ=md, (12) simplifies to

$$var ( {\hat{α}}_{unif} ) \geq \frac{{σ}^{2}}{2} \frac{3 {c}^{2}}{{π}^{2} {C}^{2} {d}^{2} {f}_{0}^{2} N ( {M}^{3} - M ) } \frac{1}{{cos}^{2} α} . \qquad ( 13 )$$

If we now consider the case of a half-wavelength spaced array with

$$d = \frac{λ}{2}$$

(13) can be further reduced to

$$var ( {\hat{α}}_{std} ) \geq \frac{6 {σ}^{2}}{{π}^{2} {C}^{2} N ( {M}^{3} - M )} \frac{1}{{cos}^{2} α} , \qquad ( 14 )$$

which also considers complex-valued data and real-valued unknowns. The general result for the array including the mirror is more involved and can be difficult to interpret in its analytical form, but choosing a fixed α=π/6 and making the assumptions that the mirror is placed λ/2 from the last array element (d_{refl}=Md) as well as an even M provides information about the achievable performance improvement due to the mirror. For this special case the use of the mirror improves the CRLB by a factor

$$\frac{var ( {\hat{α}}_{std , sc} )}{var ( {\hat{α}}_{mir , sc} )} = 8 \qquad ( 15 )$$

compared to its standard uniform array counterpart calculated via (14).

To further investigate the angular estimation accuracy improvement achievable by the mirror, the CRLB was evaluated numerically. FIG. 2 depicts the ratio of the CRLBs of \hat{α}_{std} and the CRLBs of \hat{α}ₘᵢᵣ for varying α and M where dₘ=md and d_{refl}=Md was used. It can be seen that for α not near 0 or 90 degrees, the use of the mirror improves the achievable angular estimation variance. For α approaching 0 or 90 degrees, the standard array without the mirror leads to a lower (i.e., better) CRLB. Thus for practical applications no signals originating from α near 0 or 90 degrees should impinge on the array. This can be achieved in an embodiment through the use of a transmit (TX) antenna with an accordingly narrow TX beam. Such a focusing of the TX beam is automatically achieved by the mirror element if the TX is positioned close to the mirror. In this case the real element together with the mirrored element can be seen as a two-element array leading to an increased gain depending on the mirror position relative to the TX. A more detailed investigation of this effect is described herein below. Note that the variance improvement shown in FIG. 2 does not include the increased TX gain due to the mirror element because for both CRLBs identical Cs have been assumed.

The nonlinear least squares estimator is capable of achieving the CRLB asymptotically even under non-Gaussian noise. Therefore, this approach is used in one embodiment for estimator development, since it can be expected that the angular variance improvement shown above will be achieved by this estimator. Using the stacking scheme from (8), the measured data can be written as

x=sₘᵢᵣ+v, (16)

with v being the vector of measurement noise. The notation of the dependence on the unknown parameters will be omitted going forward for notational simplicity. Using this definition, the least-squares cost function is

J=(x−sₘᵢᵣ)_{H}(x−sₘᵢᵣ). (17)

Eq. (8) can then be written as

$${s}_{mir} = \underbrace{( {I}_{N} ⊗ a )}_{A} {s}_{F} = Ae \tilde{C} = b \tilde{C} ,$$

where the vector e=[e[0]e[1] . . . e[N−1]]^{T} contains the exponential terms from (10), I_{N} is the identity matrix of dimension N, and \textcircled{x} denotes the Kronecker product. The least-squares cost function now has the form

J=(x−b\tilde{C})^{H}(x−b\tilde{C}). (18)

To find an estimate \hat{θ} for θ, the θ that minimizes (18) is found:

$$\hat{θ} = arg {min}_{θ} J .$$

Since (18) is a nonlinear function of θ but linear in \tilde{C}, the principle of separable least-squares is used in an embodiment. Using the Moore-Penrose inverse provides calculation of an estimate for the linear parameter:

\tilde{Ĉ}=(b^{H}b)⁻¹b^{H}x. (19)

Inserting (19) back into (18) leads to the new cost function:

J′=x^{H}x−x^{H}b(b^{H}b)⁻¹b^{H}x, (20)

where the dependence on the linear parameter \tilde{C} has been eliminated. To minimize (20), the following is maximized:

$$\begin{matrix}{J}^{″} = {x}^{H} {b}^{( {b}^{H} b ) - 1} {b}^{H} x \\ = \frac{{\vert {b}^{H} x \vert}^{2}}{{b}^{H} b} = \\ = \frac{1}{{Na}^{H} a} {\vert {e}^{H} ( {I}_{N} ⊗ {a}^{H} ) x \vert}_{2} ,\end{matrix} \qquad ( 21 )$$

which is known as the compressed likelihood function. An efficient implementation becomes more obvious by rewriting (21) using sums. Therefore, a is defined via its entries as a=[a₀a₁ . . . a_{M-1}]^{T} and x according to the stacking scheme from (8) as x=[χ_{0,0}χ_{1,0} . . . χ_{M-1,0}χ_{0,1} . . . χ_{M-1,N-1}]^{T}. Now (21) can be rewritten as

$${J}^{″} = \frac{1}{N {\sum }_{m = 0}^{M - 1} {\vert {a}_{m} \vert}^{2}} {\vert {\sum }_{m = 0}^{M - 1} {\sum }_{n = 0}^{N - 1} {x}_{m , n} {a}_{m}^{*} {e [ n ]}^{*} \vert}^{2} , \qquad ( 22 )$$

where. * denotes complex conjugation. The range compressed signal can be defined as

$${X}_{r} [ m ] = {\sum }_{n = 0}^{N - 1} {x}_{m , n} {e [ n ]}^{8} = {\sum }_{n = 0}^{N - 1} {x}_{m , n} {e}^{- j 2 π \frac{B}{N} \frac{2 r}{c} {n}_{1}} , \qquad ( 23 )$$

which is the DFT of the signal received at the m-th antenna evaluated at the normalized frequency

$${ψ}_{r} = \frac{B}{N} \frac{2 r}{c} .$$

Calculation of (23) for varying r is possible based on the computationally efficient FFT. Separating the parts depending on m and n and inserting (7) and (23) into (22) leads to

$${J}^{″} = \frac{1}{γ} {\vert {\sum }_{m = 0}^{M - 1} {e}^{- j {kd}_{m} u} {X}_{r} [ m ] + {e}^{- j 2 k {d}_{refl} u} {{\sum }_{m = 0}}^{M - 1} {e}^{j {kd}_{m} u} {X}_{r} [ m ] \vert}^{2} , \qquad ( 24 )$$

where the abbreviations u=sin(α) and γ=NΣₘ₌₀^{M-1}|aₘ|² have been used. Also, the sums over m in (24) can be calculated efficiently for varying α using the FFT. Thus, although (21) is a nonlinear function of r and α, a grid search over a large region of parameter combinations is feasible at low computational cost. So the final estimator for θ′=[rα]^{T} is

$${\hat{θ}}^{′} = arg {max}_{{θ}^{′}} {J}^{″} . \qquad ( 25 )$$

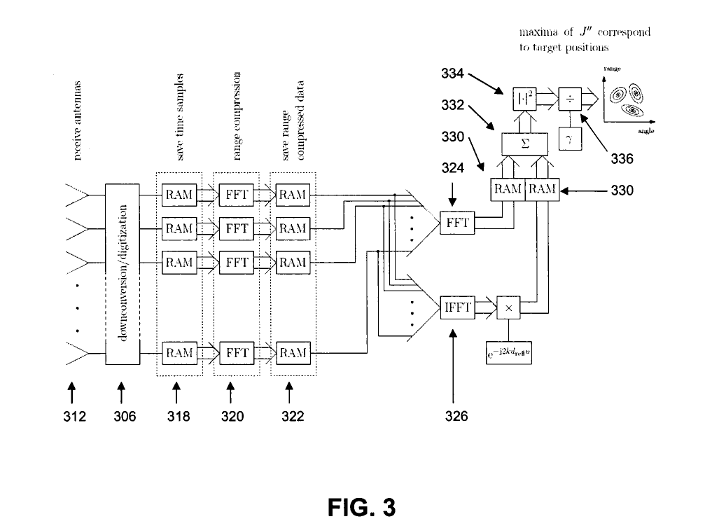

A block diagram of an embodiment of a hardware implementation of (23) and (24) is depicted in FIG. 3. Signals received by a plurality of receive antennas 312 are downconverted and digitized at block 306 and time sample data saved at memory 318. The data then undergoes range compression via FFT at 320, and the range compressed data is saved at 322. After FFT and inverse FFT at 324 and 326, respectively, the data resulting from FFT 324 is saved at 328 while the product of the data resulting from IFFT 326 and the following is saved at 330:

e^{-j2kd}^{_{refl}}^{u}.

The data at 328 and 330 is then summed and its absolute values are squared at 332 and 334, respectively, before being divided by γ at 336 to obtain J″, the maxima of which correspond to the target positions.

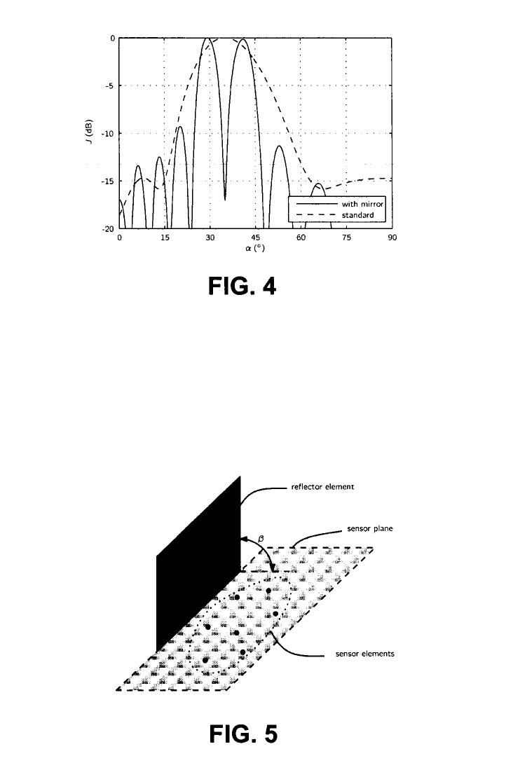

FIG. 4 is a graph showing a comparison of the least-squares cost function resulting from a standard eight element linear uniform array and from the same array including a mirror element placed half a wavelength from the end of the sensor array according to an embodiment. In FIG. 4, two completely coherent waves impinge onto the array, one from 30° and the other from 40°. This example assumes a standard linear uniform array with half wavelength spacing and eight sensor elements. It can be seen that it is impossible to resolve the waves with a standard array (shown in dashed line), whereas the cost function calculated from the array including the mirror clearly shows two distinct peaks (in solid line). The use of the mirror also provides for the use of computationally effective signal processing algorithms with minor changes, compared to classical beamforming algorithms, to account for the mirror element.

A diagram of an embodiment of sensor elements and a reflector element is depicted in FIG. 5. The embodiment of FIG. 5 is based on a planar sensor array configuration but one-dimensional or three-dimensional configurations also are possible. The reflector angle β relative to the sensor plane is drawn as 90°, but the principle can also be used with non-perpendicular configurations. Furthermore, the reflector is depicted as a flat element, but non-planar configurations are also possible in embodiments. This could, e.g., be exploited to focus the impinging waves on a certain area or to compensate phase shift that occur, e.g., in the so-called near field region, where the impinging waves cannot be modeled as plane waves. One embodiment comprises a linear configuration as shown in FIG. 1 because this results in a computationally efficient method to determine the angles of the impinging waves. Such a configuration, however, only provides measurement of one angle, i.e., either azimuth or elevation. Therefore, other configurations, such as non- or multi-linear arrangements, are used in other embodiments. First tests of the presented approach have been carried out using a radar sensor array capable of measuring the incident angle of electromagnetic waves reflected at a target and are described in more detail below.

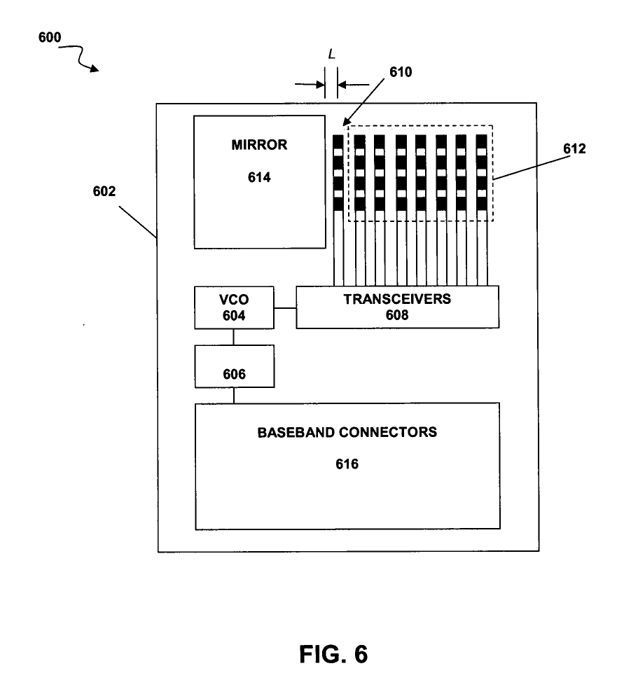

Turning to a practical implementation, a block diagram of an embodiment of an RF frontend of an eight-channel radar sensor system 600 is depicted in FIG. 6. Sensor system 600 is mounted on a printed circuit board (PCB) 602 main and, in one embodiment, comprises a voltage controlled oscillator (VCO) 604 configured to generate a transmission signal including a divide-by-eight frequency divider, a downconverter 606 including a VCO and mixer for the offset loop, and eight cascadable transceivers 608 that realize one transceiver antenna (TRX) 610 and seven receive-only channels (RX) 612. In another embodiment, transceiver antenna 610 is a transmit-only antenna. In acoustic embodiments, appropriate acoustic sensors, receivers, transmitters and other components are used, as understood by one skilled in the art.

In one embodiment, the transmission signal generated by VCO 604 is a 77 GHz signal and downconverter 606 includes a 19-GHz VCO, though in other embodiments other frequencies, components and configurations can be used. In an embodiment, transceivers 608 comprise patch antenna arrays 610 and 612, each comprising four differentially-fed patches interconnected with differential microstrip lines. The transceiver 608 closest to the mirror 614 is the TRX 610 and, in an embodiment, is placed at a distance L of λ/4 from mirror 614. In an embodiment, L is measured from mirror 614 to the center of TRX 610. Baseband connectors are shown at 616. In one embodiment, the corresponding baseband components (not shown) comprise four dual-channel 14-bit analog-to-digital converters (ADCs), a direct digital synthesizer (DDS) as a reference frequency source for a phase locked loop (PLL) in an offset loop configuration, variable gain amplifiers for the downconverted radar signals and a field programmable gate array (FPGA) to control the various components and to realize data transfer. In a prototype embodiment, data transfer is to and from a personal computer via a USB 2.0 interface.

The configuration depicted in FIG. 6 provides an increased transmit gain due to the focusing effect of mirror 614. This effect was verified in simulations calculating the TX beampattern using CST Microwave Studio® and in measurements using a single cornercube (CC) with a radar cross section of ≈11 dBsm in a distance of 2.5 m as a target. The measurements were collected in a semi-anechoic chamber with absorbers attached to one corner of the room. Due to this configuration it was possible to cover an angular range of 45 degrees with the measurements, which is sufficient to demonstrate the performance improvement as predicted by the graph shown in FIG. 2. Radar system 300 was mounted on an automatic turntable and rotated in one-degree steps. At each position |\tilde{Ĉ}|² was estimated using (19) to determine the TX beampattern. For comparison purposes the same procedure was carried out with the mirror removed from the frontend and C estimated from the conventional delay-and-sum beamformer (resulting in a 2D-FFT for the test configuration).

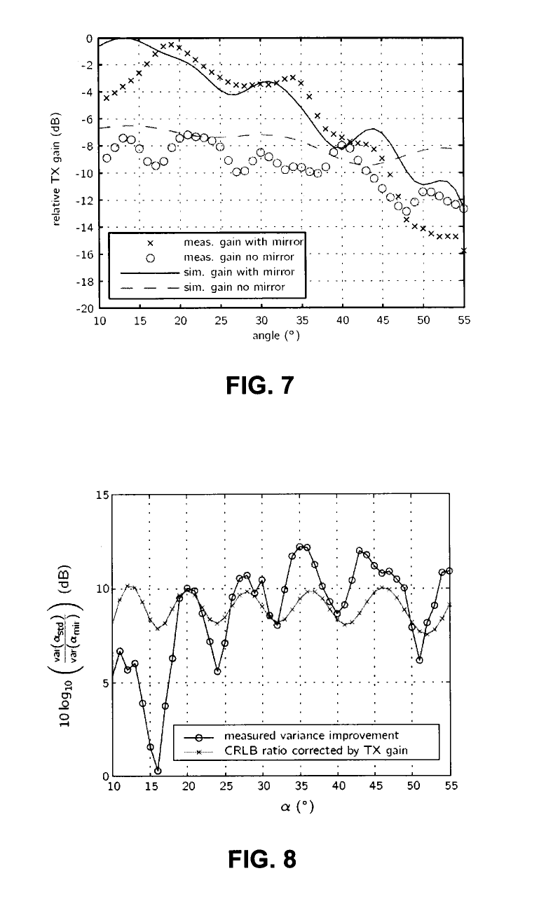

The simulated and measured results are shown in FIG. 7. As previously mentioned, these results relate to but one exemplary embodiment, and other embodiments having higher or lower transmission frequencies or other components or configurations are contemplated. The deviations between simulation and measurement results are due to the nonideal isolation of the TRX chips in the RX-only mode. This leads to a radiation of the TX signal at RX antennas 612 with unknown phase and amplitude and therefore to a slightly altered TX beampattern compared to the simulation. As a next step the achievable variance improvement as predicted by the CRLB was measured using the same CC. Again the radar was rotated in one-degree steps and at each position 200 measurements were taken with and without mirror 614. The target position was estimated using (25) for the former, and the conventional delay-and-sum beamformer for the latter. The variance improvement due to mirror 614 was calculated and compared to the theoretical values. As previously mentioned, the different Cs due to the TX beampattern need to be corrected to perform this comparison. As can be seen from (11), C² enters linearly into the FIM. Thus the increased signal-to-noise ratio due to mirror 614 can be taken into account by a corresponding decrease of the measured variance improvement.

A resulting variance improvement taking the increased TX gain into account is shown in FIG. 8 together with the ratio of the CRLBs of the systems with and without mirror 614, where FIG. 8 uses the same simulation method as used to create FIG. 2. It can be seen that the improvement due to mirror 614 is around the predicted level of 10 dB in an embodiment if the different Cs of the two systems due to the increased TX gain are taken into account. Combining the increased TX gain with the better estimation performance, the total system performance improvement due to mirror 614 even reaches around 16 dB in the direction of the maximum TX gain in embodiments.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, implantation locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A system comprising:
a radio frequency (RF) sensor array comprising a plurality of spaced apart sensors; and
a reflector element positioned proximate the RF sensor array to reflect waves toward the RF sensor array.

2. The system of claim 2, wherein the RF sensor array comprises a radar sensor array and the sensors comprise radar sensors.

3. The system of claim 2, further comprising a voltage controlled oscillator (VCO) configured to generate a signal to be transmitted by at least a portion of the radar sensor array.

4. The system of claim 3, wherein the signal is a 77-GHz signal.

5. The system of claim 1, wherein the sensor array is arranged in a first plane and the reflector element is positioned in a second plane at an angle to the first plane.

6. The system of claim 5, wherein the angle is 90 degrees.

7. The system of claim 1, wherein the sensor array comprises a transmit channel and a plurality of receive channels.

8. The system of claim 7, wherein the transmit channel comprises a transceiver.

9. The system of claim 1, wherein at least a portion of the plurality of sensors are configured to receive direct waves reflected from a target and mirrored waves reflected from the target and the reflector element.

10. The system of claim 9, wherein the mirrored waves create a virtual sensor array spaced apart from the sensor array.

11. The system of claim 9, wherein the system is configured to measure an incident angle of waves that impinge on the radar sensor array, and wherein at least one of an improved angular accuracy or resolvability of the incident angle is achieved by computationally resolving the direct waves and the mirrored waves received by the radar sensors.

12. The system of claim 1, wherein the system is integrated in an integrated circuit.

13. A system comprising:
an antenna array comprising a transmit antenna and a plurality of receive antennas;
a mirror arranged proximate the antenna array;
a voltage controlled oscillator (VCO) configured to generate a signal to be transmitted by the transceive antenna; and
a controller configured to resolve signals received by the plurality of receive antennas to determine an angular position of a target, wherein the signals received include a first portion of the signal reflected by the target and a second portion of the signal reflected by the target and the mirror.

14. The system of claim 13, wherein the signal is a 77-GHz signal.

15. The system of claim 13, wherein the transmit antenna comprises a transceiver.

16. The system of claim 13, wherein the mirror is arranged half a wavelength away from the tranceive antenna.

17. The system of claim 13, wherein the system is integrated in an integrated circuit.

18. The system of claim 13, wherein the plurality of receive antennas comprise seven receiver channels.

19. A method comprising:
transmitting a radio frequency (RF) signal;
receiving a first portion of a reflected RF signal reflected by a target;
receiving a second portion of a reflected RF signal reflected by a target and a reflector; and
resolving the first and second portions to determine an angular position of a target.

20. The method of claim 19, further comprising generating the RF signal.

21. The method of claim 19, further comprising forming a module comprising at least one transceive antenna, at least one receive antenna and the reflector, wherein the reflector is positioned proximate the transceive antenna, the at least one transceive antenna is configured to transmit the RF signal and the at least one receive antenna is configured to receive the first and second portions of the reflected RF signal.

22. The method of claim 21, wherein forming further comprises arranging the reflector spaced apart from the transceive antenna by one-half wavelength.

23. The method of claim 19, wherein resolving further comprises determining a position of the target as a maxima of J″, wherein J″ is
$$\frac{1}{γ} {\vert {\sum }_{m = 0}^{M - 1} {e}^{- j {kd}_{m} u} {X}_{r} [ m ] + {e}^{- j 2 {kd}_{refl} u} {\sum }_{m = 0}^{M - 1} {e}^{j {kd}_{m} u} {X}_{r} [ m ] \vert}^{2} .$$

24. A method comprising:
increasing an effective array aperture of a radar sensor array by positioning a mirror proximate the radar sensor array;
receiving target-reflected signals and target-and-mirror-reflected signals by the radar sensor array; and
determining information about a target based on the target-reflected signals and target-and-mirror-reflected signals.

25. The method of claim 21, wherein determining further comprises determining at least one of an angular position or a distance of the target.
